(19) United States
(12) Patent Application Publication
(10) Pub. No.: US 2002/0052845 A1
(43) Pub. Date: May 2, 2002

(54) Methods and apparatus for self service networks

(75) Inventor: Paul Nielsen, St. Andrews (GB)

Correspondence Address: Michael Chan, NCR Corporation, Intellectual Property Section, Law Department, 1700 South Patterson Blvd., Dayton, OH, 45479-0001, US

(73) Assignee: NCR Corporation

(21) Appl. No.: 09/966,027

(22) Filed: Sep. 28, 2001

(30) Foreign Application Priority Data
Oct. 27, 2000 (GB) 0026362.4

(51) Int. Cl. G06F 17/60

(52) U.S. Cl. 705/43

(57) ABSTRACT

An ATM network comprises ATM's (22-1, 22-2, 22-3) coupled by an ATM switch (24) to a processor (26) and data warehouse (28). Information may be gathered about performance of the ATM network (20) and used to generate rules (34) for adjusting transaction charges incurred by use of the ATM. The rules may take into account usage patterns of the ATM and also collateral data such as weather forecasts and local event fixture lists.

### BACKGROUND OF THE INVENTION

This invention relates to a self-service network, to a server for a self-service network, to a self-service terminal for a self-service network and to methods of operating and configuring a self service terminal.

The banking market is moving increasingly towards a situation in which retail banking operations such as dispensing cash, taking check deposits and ordering check books and statements are carried out away from or outside bank premises using terminals such as automated teller machines (ATM). This often provides a more convenient service for customers and can in some case reduce bank overheads.

However, the installation and maintenance of ATM's incurs costs and additionally, where a user uses the services of an ATM from a “foreign” bank (in the sense of it not being the bank which has issued the card or other identification means to the user), charges are incurred which are payable by the issuer bank.

As a result, banks have started to charge users directly for the use of ATM's in the form of a transaction or usage charge made at the time a transaction is carried out using an ATM machines this charge is typically debited to the users account at the issuer bank. To date, such charging has been made on the basis of whether a user is using an ATM from his/her issuer bank or not. Furthermore, the charge levels have been uniform across the whole network in a particular country.

### SUMMARY OF THE INVENTION

In accordance with the first aspect of the invention, there is provided a self-service network comprising a network server and a plurality of self service terminals communicatively couplable to the server, each terminal being arranged to send performance data to the server which is representative of the occurrence of operations carried out by the terminal.

The performance data may for example be representative of customer usage of each terminal. The performance data typically includes information representative of the type of transactions and/or of the time at which transactions are initiated at each terminal.

By arranging for each terminal to be responsive to commands received from the server to the operation of a respective terminal, the server may in response to the performance data, command a terminal dynamically, to alter the operation of the terminal, for example by altering the value of a usage charge charged to the user performing a transaction at the terminal.

Thus for example, the value of a usage charge may increase at peak times such as lunch times, when more users use the terminal. In this way, the user may benefit from reduced charging at times of lower usage.

According to a second aspect, the invention provides a self service terminal for a client/server self-service network, which is arranged to send performance data to a network server which data is representative of the occurrence of operations carried out by the terminal.

According to a third aspect, the invention provides a server for a self service network, arranged to receive performance data over the network which is representative of the occurrence of operations carried out by a terminal in the network and to analyze the data to determine performance patterns for the terminal.

According to a method aspect of the invention, there is provided a method of configuring a self-service terminal comprising the steps of gathering performance data which is representative of performance of the terminal, analyzing the performance data to determine performance patterns, and generating one or more rule which map changes in terminal performance to changes in one or more operational parameter of the terminal.

According to a second method aspect, having configured a self service terminal according to the method above, the invention provides a method of operating a self service terminal comprising automatically applying the or each rule to regulate the operation of the terminal.

According to a third method aspect, there is provided a method of operating a self service terminal comprising the steps of determining an expected usage pattern of the terminal, and automatically adjusting the value of a usage charge dependent on the expected usage pattern.

Preferably the amount of the usage charge is displayed at the terminal immediately before the transaction is ready to be processed. At this stage in the transaction, the user will typically have provided several user inputs via a user interface of the terminal and will be committed to performing the transaction.

Alternatively, the amount of the usage charge may be displayed at the terminal before or during the user interaction steps at the user interface of the terminal which lead up to the transaction being ready to be processed. In this way, the user may choose not to proceed with a transaction based on the cost of performing the transaction, at an earlier stage in the procedure leading up to the transaction being ready to be processed.

The term “self-service apparatus” is used herein to refer to unattended apparatus which may receive user input and/or provide information to a user, for example about a bank account. Such self-service apparatus (or terminal) may also be arranged to allow a user to initiate and/or complete transactions such as purchasing items or withdrawing money from a bank account, whilst being unattended by anyone other than the user. Examples of self-service apparatus include automated teller machines (ATM), vending machines and non-cash kiosks with touch screen displays. Another example is a web-enabled, interactive display forming an integral part of a fuel dispensing pump in an automotive fuel station.

The term “deployer” is used herein to refer to an owner or controller of a plurality (fleet) of self-service terminals.

Actions or processes that are initiated and completed instantaneously after the occurrence of one or more trigger events are said to be completed in “real time”. For example, many ATMs in current usage operate to update bank account details using on-line transaction processing (OLTP) which is substantially real time. In contrast, batch processing, which often involves manual input of data into a computer system, for example, at the end of each working day, is not “real time”. In batch processing, trigger events such as bank account transactions occur during the working day, but actions or processes to log these transactions in a central computer system only occur once a plurality of trigger events have accumulated. For example, this may be at the end of each day. An advantage of this is that processing a batch of items is often more computationally efficient and the processing can take place at “non-busy” times. A continuum can then be thought of with batch processing at one end of the continuum and real time processing at the other end of the continuum. The term “near real time” is used to refer to processing that is not strictly real time, but which is closer to the real time end of the continuum than the batch processing end of the continuum.

The term “kiosk” is used herein to refer to a type of self-service apparatus which does not operate using cash.

The term “data warehouse” is used to refer to a storage means which is able to store data in such a manner that it is easily and quickly accessible in real time. A data warehouse is also operable to perform complex pattern analysis of the data.

### BRIEF DESCRIPTION OF THE DRAWINGS

Embodiments of the invention will now be described by way of example with reference to the drawings in which:

FIG. 1 is a schematic block diagram of a typical ATM network having ATM's shared between more than one ATM deployer;

FIG. 2 is a schematic block diagram showing the possible charges incurred during a transaction on a foreign ATM;

FIG. 3 is a schematic block diagram of a ATM network in accordance with the invention; and

FIG. 4 is a flowchart showing the configuration and operation of an ATM in accordance with the invention.

### DETAILED DESCRIPTION

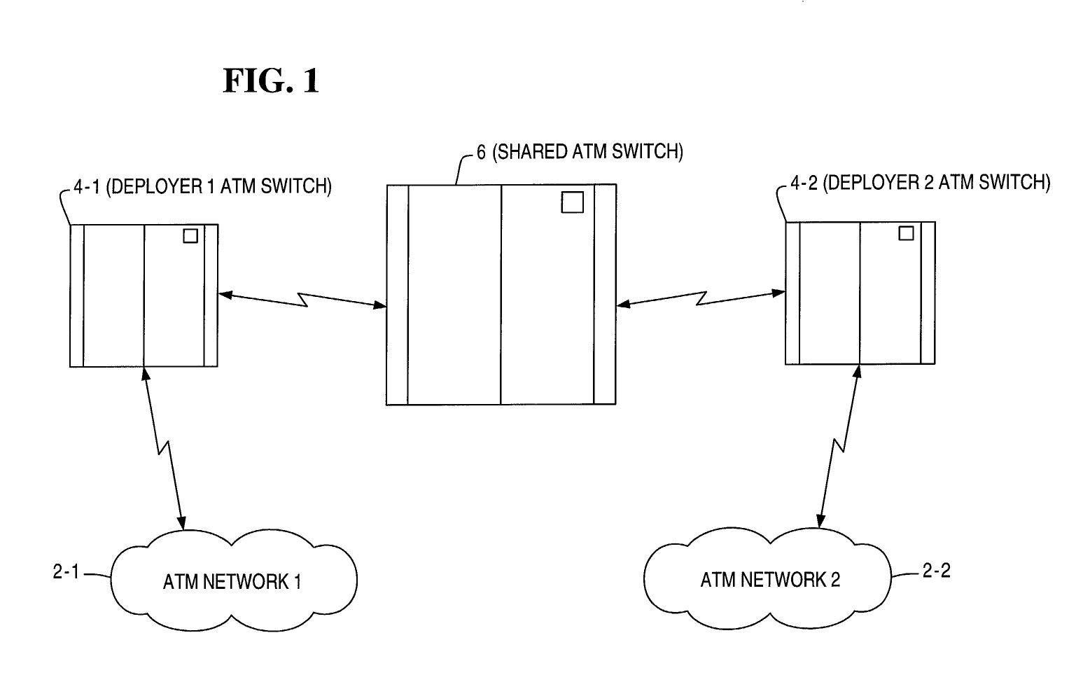

With reference to FIG. 1, a first ATM network 2-1 comprises a plurality of ATM's (not shown) communicatively coupled to a first ATM switch 4-1.

The network 2-1 is associated with a first deployer which may for example be a particular issuer bank. Transactions within the first ATM network 2-1 occur entirely under the control of the first issuer bank and thus do not generally incur charges other than the internal overheads of running the network.

However, it is common for ATM deployers to reach agreements with third parties who have other networks of ATM's. Thus, a second deployer (for example another bank) has a second ATM network 2-2 communicatively coupled to a second ATM switch 4-2.

For a customer of the first deployer to use an ATM machine in the second ATM network 2-2, it is necessary to interconnect the networks so that requests and responses can flow between the networks 2-1 and 2-2.

This is typically achieved by interconnecting the first and second ATM switches 4-1 and 4-2 to a shared ATM switch 6 operated by an independent party or, for example, a syndicate of ATM deployers.

It will be appreciated that the representation of FIG. 1 is much simplified. In practice, there are likely to be many deployer networks, deployer switches, and/or shared switches.

Thus, a request for a transaction made in the “foreign” ATM network 2-2 for a user who is a customer of issuer bank or deployer 1 of the ATM network 2-1, will be passed via the shared ATM switch 6 and the first ATM switch 4-1 to be processed by the issuer bank. Any responses from the issuer bank will similarly be passed back to the ATM network 2-2 via the shared ATM switch 6.

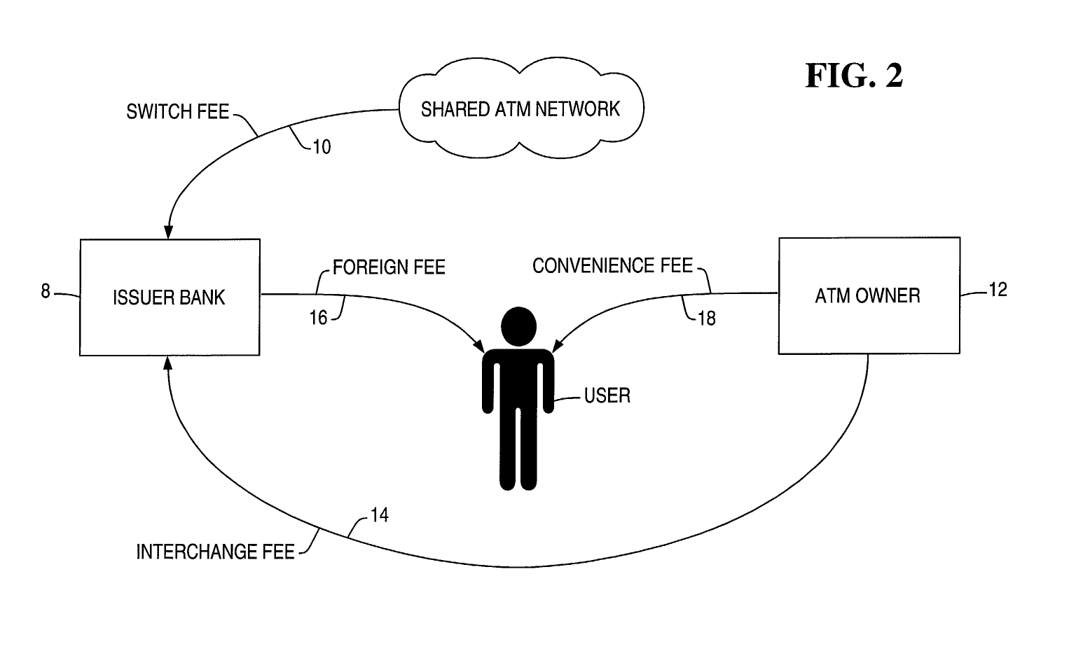

However, with reference to FIG. 2, the type of transaction noted above incurs charges.

Typically there are four charges incurred when a foreign ATM is used. The first two of these fees are “wholesale” charges which are charged to the issuer bank 8.

Firstly, a “Switch Fee” 10 is charged by the owner of the shared ATM switch 6. Also, the owner of the ATM (in ATM network 2-2 in the example above) 12 makes a charge to the issuer bank 8 called an “Interchange Fee” 14, for use of the ATM's.

The first and fourth charges (which are “retail” charges which may be made to the user) are a “Foreign Fee” (also known as a disloyalty or issuer fee) 16 charged by the issuer bank 8 and also a surcharge or “Convenience Fee” 18 (also known as an acquirer fee or surcharge) charged by the ATM owner 12.

It is desirable to be able to choose to operate the self-service terminal at dynamically varying positions on the supply-demand curve by dynamically varying the associated charging structure, for example, to match the expected demand and/or in response to the characteristics of the ATM network.

The present invention tackles this requirement in two stages. Firstly, information is gathered about the performance of the network in relation, for example, to time. The performance of the network will typically be measured by monitoring the type of transactions performed and the time at which they are performed. By analyzing this data, a picture can be built up of the volume of usage and the type of usage at particular times of the day and on particular days.

Such data may then be cross-referenced with collateral data such as the number of ATM machines from “on-us” or foreign (not on-us) deployers in the geographical location of a particular ATM, the weather and/or the occurrence of local events such as sporting events (which bring larger numbers of people to the area of the ATM).

Having analyzed the data to build up a picture of usage, rules may be constructed based on the time of day, the particular day and/or collateral data such as weather forecasts and sporting fixture lists, to adjust the operational characteristics of the ATM (such as the level of usage charges).

In the second stage, the rules are applied to cause dynamic (real time or near real time adjustment) of ATM charges.

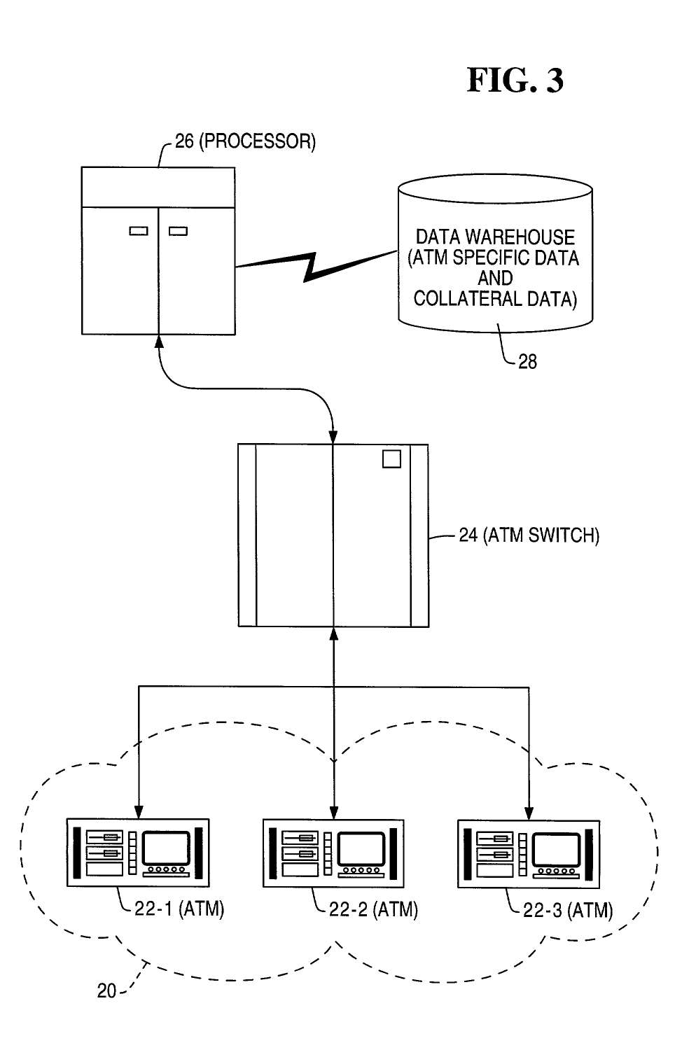

FIG. 3 shows a typical network structure which allows the scheme set out above to be implemented.

An ATM network 20 containing a plurality of ATM's 22-1, 22-2 and 22-3 may be of the type shown in the whole of FIG. 1 above or may comprise only an “on-us” network such as 2-1 or 2-2 of FIG. 1.

The ATM's 22-1, 22-2, 22-3 are arranged to send data to their respective deployer switches from which at least the type of transaction and time of transaction can be derived. This data is passed via an ATM switch 24 (which may for example be the ATM switch 6 or one of the ATM switches 4-1, 4-2 of FIG. 1) to a processor 26. The processor is coupled to a data warehouse 28 which may, for example, be a Teradata (Trade Mark) data warehouse which is operable to store large amounts of data and to perform complex analysis on that data. It will be appreciated that the data warehouse 28 may physically be a plurality of distributed databases which typically would be logically associated into one or more data warehouse.

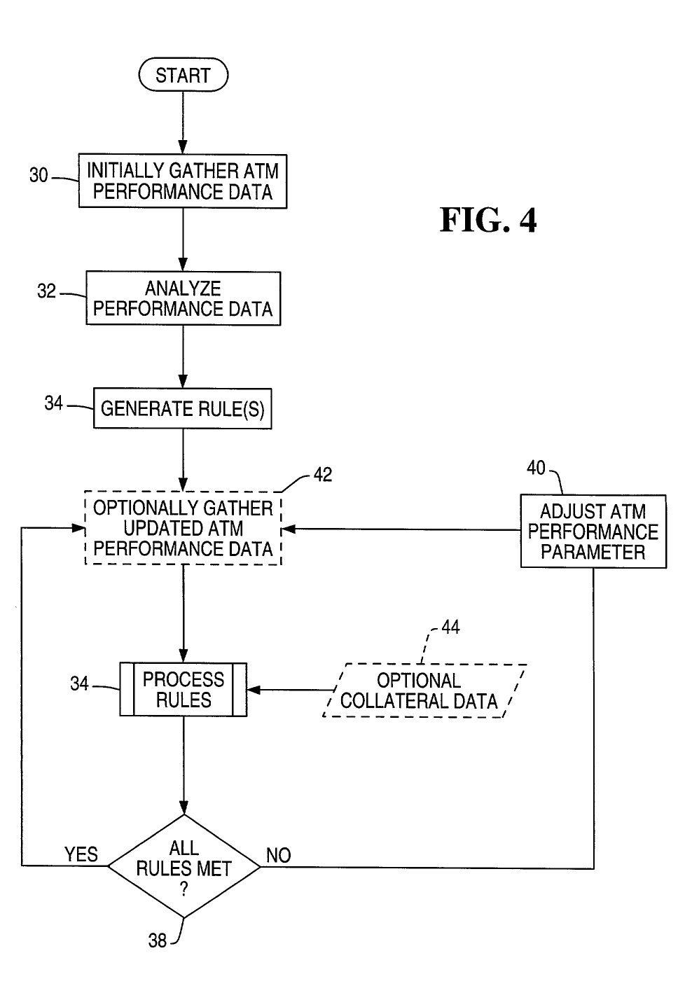

With reference to FIG. 4, the ATM charging structure outlined above is configured initially by gathering ATM performance data (step 30). This is achieved by operating the network for a predetermined period of time and recording performance data of the ATM's 22-1, 22-2, 22-3 in the data warehouse 28.

The data warehouse 28 may also include collateral data such as that set out above i.e. weather forecasts and/or events fixture lists.

Next, the performance data is analyzed (step 32) to determine trends or patterns in usage of the ATM's 22-1, 22-2, 22-3 over time or in relation to the collateral data. This allows usage of the ATM to be forecast. For example, it can be forecast that the ATM will be used heavily at certain times of the day or when events are occurring at local facilities such as sport stadiums, cinemas or theatres.

Once the patterns and trends have been identified, the next step 34 is to generate one or more rule which maps input data such as the time of day or current collateral data to desired changes in the pricing structure for particular ATM's. Thus, for example, the price of performing certain transactions on an ATM using an ATM may be increased for a time period spanning an hour before and an hour after a football match occurring in a stadium close to the ATM. Similarly, it may be desirable to increase charging levels on a wet day since a customer having taken trouble to approach an ATM on such a day will probably have a greater need of the transaction than a customer who happens to be passing on a dry day.

The process undertaken by the processor 26 then proceeds to step 36 in which the rules generated in step 34 are applied by a loop comprising step 38 which checks that the rules are met and step 40 which adjusts one or more ATM performance parameter (such as charging levels) if necessary.

As customers use the ATM, the ATM characteristics in force at the time of the transaction are recorded along with the transaction details. Thus, the charge for a transaction may be recorded at the time of the transaction and passed through the network to the issuer bank for settlement, i.e. debiting from the customer's account.

Preferably, information is periodically or continually gathered within the loop (step 42) to allow analysis of the effect particular charging structures to be undertaken. Thus, for example, it may be desirable to try a higher or lower usage charge value on a particular day at a particular time, to gather information for that particular period about usage levels (step 42) and compare this with “control” usage levels under a pre-existing charging structure. This provides a degree of feedback so that the charging structure can be optimized.

Also, as mentioned above, collateral data 44 may optionally be incorporated into the processing of the rules (step 36) in order that the performance of the ATM may be altered by an ‘awareness’ of the surroundings of the ATM.

As described above, it will be seen that the data gathering and processing is performed largely centrally using processor 26 and data warehouse 28. This will typically be the most cost effective and reliable form of operation. However, depending on the processing power of the ATM's 22-1, 22-2, 22-3, it may be chosen to perform some analysis and rule processing locally. The rules could for example be downloaded over the ATM network so that they may be periodically updated. This reduces network bandwidth requirements but at the cost of ATM hardware requirements. And thus the decision about where to base the “intelligence” within the network is largely an economic one.

The basic theme is that by analyzing and recording performance information about the ATM, the charging structure may more accurately reflect the expectations and needs of the customers.

Similarly, the connection that the ATM's 22-1, 22-2, 22-3 have with the ATM switch 24 may be varied according to the speed with which price changes need to be made and the amount of usage date which needs to be transmitted. At the most comprehensive end of the range, a “permanently on” connection may be provided. Alternatively, the ATM may be provided with apparatus for making a cellular telephone connection to the ATM switch (for example using a GSM or AMPS-based communications card).

Typically the transaction charge is displayed on the display apparatus incorporated in the ATM. The transaction charge may not be displayed until the transaction is ready to be processed in which case a consumer is unlikely to be deterred from completing the transaction solely on the basis of the charge. Alternatively, the charge may be displayed early on in the steps leading up to the transaction or permanently on the display device before user interaction is initiated.

What is claimed is:

1. An self-service network comprising:
a network server; and
a plurality of self service terminals communicatively couplable to the server, each terminal including means for sending performance data to the server which is representative of the occurrence of operations carried out by the terminal.

2. A network according to claim 1, wherein the performance data is representative of customer usage of each terminal.

3. A network according to claim 1, wherein the performance data includes information representative of the type of transactions and/or of the time at which transactions are initiated at each terminal.

4. A network according to claim 1, wherein each terminal includes means responsive to commands received from the server and for altering the operation of a respective terminal.

5. A network according to claim 1, wherein each terminal includes means responsive to server commands and for altering the value of a usage charge charged to a user of a respective terminal.

6. A self-service terminal for a client/server self-service network, the terminal comprising:
a mechanism for sending performance data to a network server which data is representative of the occurrence of operations carried out by the terminal.

7. A self-service terminal according to claim 6, wherein the performance data is representative of customer usage of the terminal.

8. A self-service terminal according to claim 6, wherein the performance data includes information representative of the type of transactions.

9. A self-service terminal according to claim 6, wherein the performance data includes information representative of the time at which transactions are initiated at the terminal.

10. A self-service terminal according to claim 6, further comprising means responsive to commands received from the server and for altering the operation of the terminal.

11. A self-service terminal according to claim 10, further comprising means responsive to server commands and for altering the value of a usage charge charged to a user of the terminal.

12. A server for a self-service network, the server comprising:
means for receiving performance data over the network which data is representative of the occurrence of operations carried out by a terminal in the network; and
means for analyzing the data to determine performance patterns for the terminal.

13. A server according to claim 12, wherein the performance data is representative of customer usage of the terminal.

14. A server according to claim 13, wherein the performance data includes information representative of the type of transactions and/or of the time at which transactions are initiated at the terminal.

15. A server according to claim 12, further comprising means for issuing commands to the terminal to alter the operation of the terminal

16. A server according to claim 15, wherein the server is arranged to issue a command to the terminal to alter the value of a usage charge charged to a user of the terminal.

17. A method of configuring a self service terminal comprising the steps of:
(a) gathering performance data which is representative of performance of the terminal;
(b) analyzing the performance data to determine performance patterns; and
(c) generating one or more rule which map changes in terminal performance to changes in one or more operational parameter of the terminal.

18. A method according to claim 17, wherein the performance data is representative of customer usage of the terminal.

19. A method according to claim 17, wherein the performance data includes information representative of the type of transactions and/or information representative of the time at which transactions are initiated at the terminal.

20. A method according to claim 17, wherein the or one of the operational parameters is the value of a usage charge charged to a user of the terminal.

21. A method of operating a self-service terminal according to claim 17, further comprising the step of automatically applying the or each rule to regulate the operation of the terminal.

22. A method of operating a self-service terminal comprising the steps of:
(a) determining an expected usage pattern of the terminal; and
(b) automatically adjusting the value of a usage charge dependent on the expected usage pattern.

23. A method according to claim 22, wherein the expected usage pattern is determined by analyzing historical data representing usage of the terminal over a predetermined period of time.

24. A method according to claim 23, wherein the historical data includes information about the type of transactions carried out at the terminal.

25. A method according to claim 23, wherein the historical data includes information about the time at which transactions have been carried out at the terminal.

26. A method according to claim 22, wherein the expected u sage pattern includes information about the volume of transactions carried out at the terminal at different times of the day and/or on different days.

27. A method according to claim 22, wherein the expected usage pattern is determined by analyzing the effect on terminal usage caused by events which are not operational events of the terminal.

28. A method according to claim 22, wherein the usage charge is adjusted dependent on the determined expected usage pattern and on collateral data representing events which are not operational events of the terminal.

29. A method according to claim 22, further comprising the step of:
(c) displaying the amount of the usage charge at the terminal immediately before the transaction is ready to be processed.

30. A method according to claim 22, further comprising the step of:
(c) displaying the amount of the usage charge at the terminal before or during the user interaction steps at the user interface of the terminal which lead up to the transaction being ready to be processed.
